(19) United States
(12) Patent Application Publication
(10) Pub. No.: US 2014/0119591 A1
(43) Pub. Date: May 1, 2014

(54) MICRO-SPEAKER

(71) Applicant: Yiming Meng, Shenzhen (CN)

(72) Inventor: Yiming Meng, Shenzhen (CN)

(73) Assignees: AAC MICROTECH(CHANGZHOU) CO., LTD, Changzhou (CN); AAC ACOUSTIC TECHNOLOGIES (SHENZHEN) CO., LTD., Shenzhen (CN)

(21) Appl. No.: 14/147,133

(22) Filed: Jan. 3, 2014

Related U.S. Application Data
(63) Continuation-in-part of application No. 13/190,451, filed on Jul. 25, 2011.

(51) Int. Cl. H04R 1/00

(52) U.S. Cl. CPC H04R 1/00
USPC 381/386

(57) ABSTRACT

A micro-speaker is disclosed. The micro-speaker includes a frame defining a hollow space, a diaphragm attached to the frame, a voice coil positioned on the diaphragm, a cover covering the diaphragm and attached to the frame forming a housing, a yoke received in the hollow space and attached to the frame, a magnet received in the yoke, and a pole plate attached on the magnet. The yoke includes a bottom wall, and two ends of the base wall are provided with a groove corresponding to the magnetic gap, respectively. A width of the groove is greater than a thickness of the voice coil.

### RELATED PATENT APPLICATION

This application is a continuation-in-part of U.S. patent application Ser. No. 13/190,451, filed Jul. 25, 2011, entitled “micro-speaker”, which is hereby incorporated by reference in its entirety.

### FIELD OF THE INVENTION

The present disclosure relates to transducers to be mounted in terminal equipment for converting electrical signals to audible sounds, and more particularly to a micro-speaker.

### DESCRIPTION OF RELATED ART

Sound which can be heard by a person's auditory sense is transmitted in the form of waves. The sound having the wave form moves air molecules and vibrates the tympanic membrane, thus allowing a person to hear the sound. In order to provide audible sounds, various kinds of speakers have been developed. The speaker is generally coupled to audio equipment or an amplifier for use as a large sound producing means for considerably amplifying volume. Alternatively, the speaker may be used as a small sound producing means having small size and volume.

As such, the small-sized speaker may be mounted to a small electronic product, such as a mobile phone, a PDA, or a notebook computer. As the wireless age begins, consumers want to consume various contents regardless of time and place and demand portability. In order to satisfy the consumers' desires, speakers are tending towards miniaturization and lightness.

A micro-speaker related to the present disclosure includes a case defining a sound hole, a frame attached to the case for forming a chamber, a magnetic circuit defining a magnetic gap, a diaphragm located in the chamber, and a voice coil attached to the bottom of the diaphragm. Typically, the magnetic circuit includes a yoke, a magnet positioned on the yoke, and a top plate attached to the magnet. The magnetic gap is formed between the yoke and the magnet, and the voice coil is suspended in the magnetic gap. While electrified, the voice coil will be activated to vibrate by the electromagnetic Ampere Force and further drives the diaphragm to vibrate, which converts the electrical signals to sound waves. However, as mentioned above, as the micro-spacer is designed smaller and thinner, no extra space is provided for the voice coil to vibrate with sufficient amplitude. In many cases, the voice coil even will collide to the bottom of the yoke so as to badly affect the frequency sound quality produced by the diaphragm.

U.S. patent application Ser. No. 13/057,048 provides a yoke made of iron or like as a magnetic member, the yoke including a bottom in substantially rectangular shape, a long sidewall and a short sidewall. Four yoke notched parts in round shape are formed by two adjacent sidewalls for coupling the yoke to a frame by corresponding four guide members brought into contact with the yoke notched parts, respectively. In fact, this type of construction does not provide an extra space for the voice coil to vibrate with sufficient amplitude.

Therefore, it is desirable to provide a micro-speaker which can overcome the above-mentioned problems.

### BRIEF DESCRIPTION OF THE DRAWINGS

FIG. 1 is an isometric exploded view of a micro-speaker in accordance with an exemplary embodiment of the present disclosure;

FIG. 2 is an illustrative cross-sectional view of the micro-speaker in FIG. 1;

FIG. 3 is an isometric view of the micro-speaker in FIG. 1, with a housing thereof being removed away;

FIG. 4 is an isometric view of a yoke of the micro-speaker in FIG. 1;

FIG. 5 is an isometric view of a magnetic circuit of a micro-speaker in accordance with another embodiment of the present disclosure;

FIG. 6 is an illustrative cross-sectional view of the magnetic circuit taken along line A-A in FIG. 5.

Many aspects of the embodiment can be better understood with reference to the drawings mentioned above. The components in the drawings are not necessarily drawn to scale, the emphasis instead being placed upon clearly illustrating the principles of the present disclosure. Moreover, in the drawings, like reference numerals designate corresponding parts throughout the several views.

### DETAILED DESCRIPTION OF THE EXEMPLARY EMBODIMENTS

Reference will now be made to describe exemplary embodiments of the present disclosure in detail.

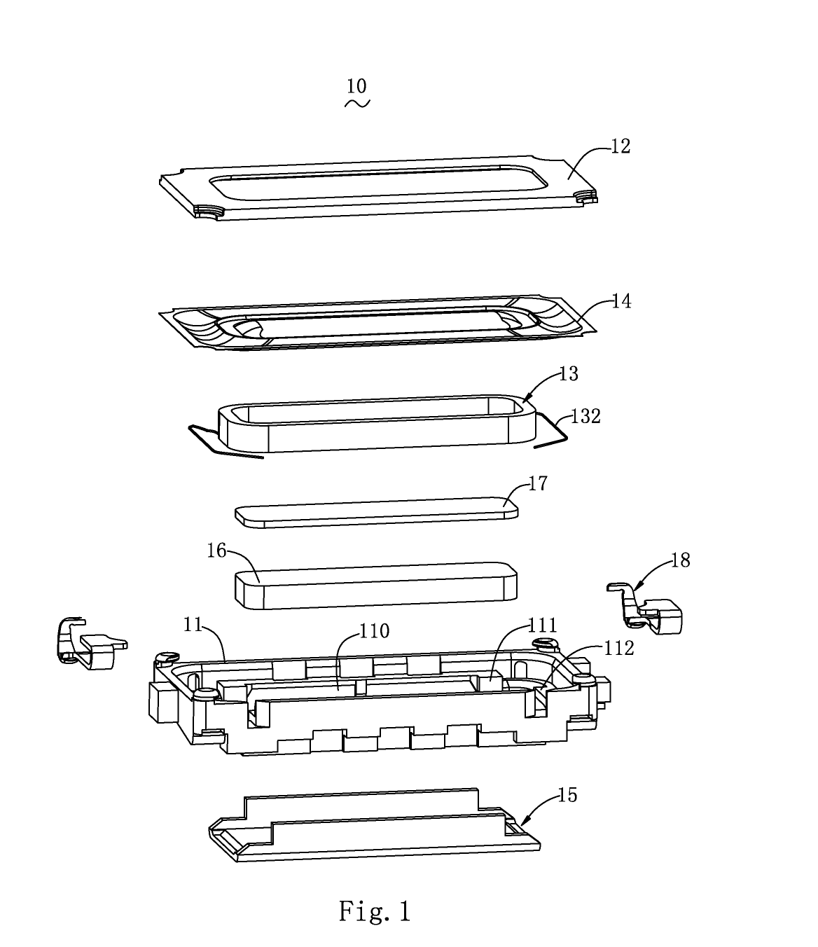

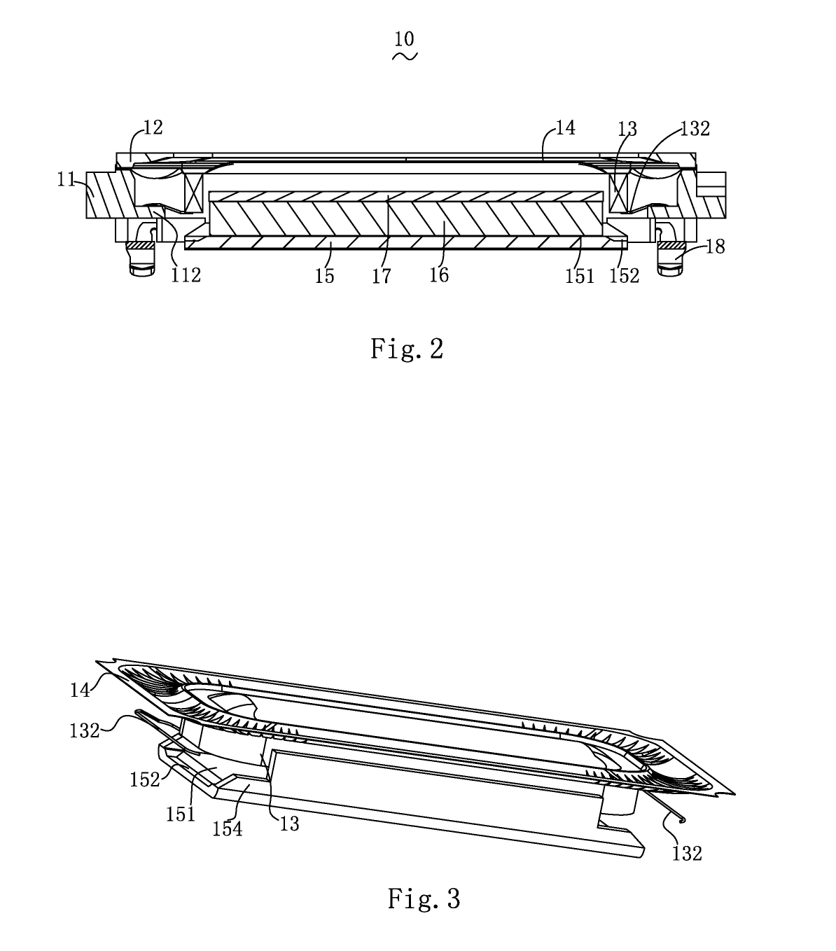

Referring to FIGS. 1 through 3, an exemplary embodiment of the present invention discloses a micro-speaker 10 comprising a frame 11 forming a hollow space 110, a diaphragm 14 attached to the frame 11, a cover 12 covering the diaphragm 14 and attached to the frame 11, a yoke 15 engaged with the frame 11, a magnet 16 received in the yoke 15, a pole plate 17 attached on the magnet 16, and a voice coil 13 activating the diaphragm 14. Further, a pair of conductive terminals 18 is provided in the frame electrically connected to leads 132 of the voice coil 13. Thus, the voice coil 13 can receive electrical signals via the conductive terminals 18. A magnetic gap is formed between the yoke 15 and the magnet 16. In addition, the frame 11 further defines a plurality of positioning portions 111 extending from inner sidewalls thereof.

In particularly, the frame 11, cooperatively with the cover 12 forming a housing, defines a chamber therebetween for receiving the yoke 15, the magnet 16, the pole plate 17, the voice coil 13 and the diaphragm 14 therein. One end of the voice coil 13 is connected directly or indirectly with the diaphragm 14, the other end of the voice coil 13 is at least partially received in the magnetic gap. The frame 11 further includes a fence 112 extending from inner sidewalls of the frame 11 and received in a hollow space 110 for embedding the pair of conductive terminals 18 in proper position so as to electrically connect with the leads 132 of the voice coil 13. In the embodiment, the leads 132 extend from the end far away from the diaphragm 14. While electrified, the voice coil 13 is activated to move by Lorenz Force, and accordingly, the diaphragm 14 is driven by the voice coil 13, which produces sound waves.

Referring to FIG. 3, the yoke 15 includes a base wall 151 in shape of rectangle having a long boundary and a short boundary, and a pair of longitudinal sidewalls 154 extending upwardly and perpendicularly from the longitudinal outer periphery of the base wall 151. Each of the longitudinal sidewalls 154 comprises a main wall 155 and a pair of auxiliary walls 156 extending from two ends of the main wall 155, respectively. A height of the main wall 155 is greater than that of the auxiliary wall 156. An inclining portion 153 extends from the auxiliary wall 156. In the embodiment, the magnetic gap and the voice coil 13 11 may be a rectangular-shaped or elliptical-shaped configuration accordingly to the yoke 15.

Accordingly, each of the longitudinal sidewalls 154 further comprises a nick 157 formed by the main wall 155 and the auxiliary wall 156 for engaging with the positioning portion 111 for positioning the frame 11. Each of the two ends of the base wall 151 is provided with a groove 152 located between two main walls 15 and closed to the inclining portions 153. That is to say, two grooves 152 are located on two ends of the base wall 151 and near to the short boundary, respectively. The term “groove” here means to a rectilineal or arc-shaped trough without through hole. Consequently, the leads 132 are provided on the short-side of the voice coil 13 corresponding to the groove so that a part of the leads may be suspended in the groove 152 during vibration so as not to bump against the base wall 151 of the yoke 15.

Alternatively, the yoke 15 may be includes a closed-loop recess designed on the bottom of the yoke for providing an extra space to accommodate the voice coil 13 such that the voice coil 13 can oscillate freely relative to the frame 11.

While assembled, the voice coil 13 can be partially received in the magnetic gap and is suspended above the groove 152. In order not to limit the vibration of the voice coil 13 completely, the groove 152 is designed to have a width greater than that of the thickness of the voice coil 13. The leads 132 are used as a flexible wire electrical directly connected the conductive terminals 18. The flexible wire is sway with the vibration of the voice coil 13 such that it may be received in the groove 152 without contacts the yoke 15.

Consequently, while vibrating, the voice coil 13 is intermittently received in the magnetic gap for avoiding dump the base wall 151 of the yoke 15.

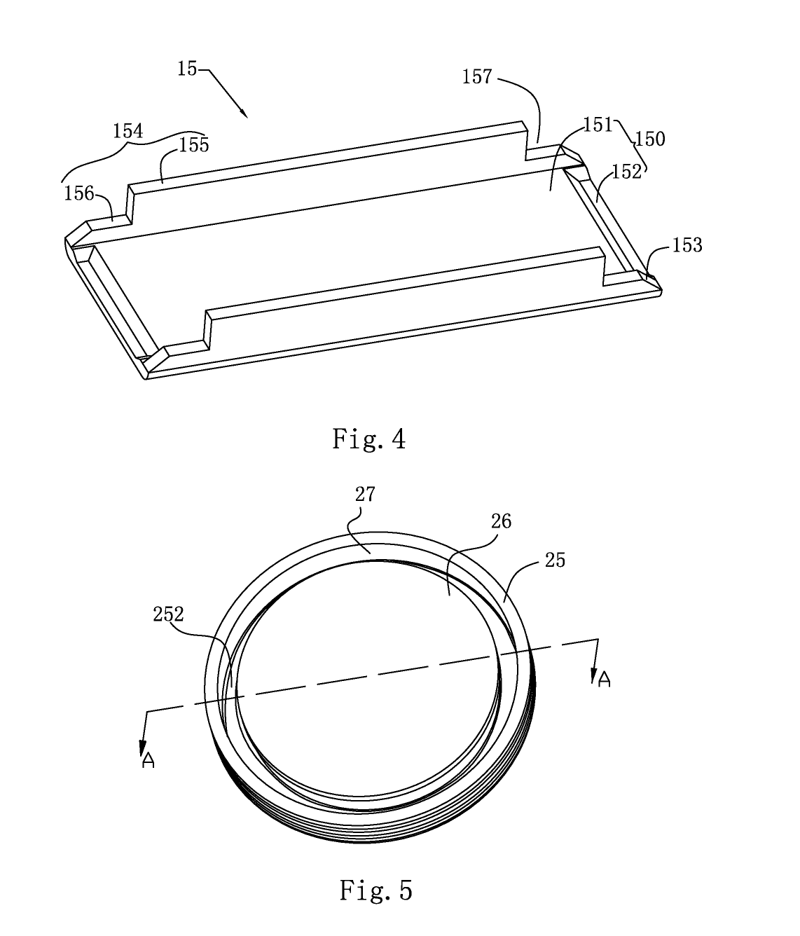

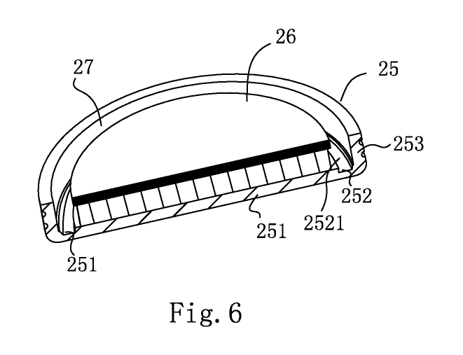

The shape of the yoke 11 is not restricted to rectangle as described in this embodiment. Referring to FIGS. 4 and 5, another type of yoke 25 is configured to be like a bowl and has a receiving space for accommodating a magnet 26. The yoke 25 comprises a base wall 251 in shape of circle and a sidewalls 253 extending upwardly and perpendicularly from the base wall 251. A magnetic gap 27 is formed between the magnet 26 and the sidewall 253 of the yoke 25. The yoke 25 further includes a ring-shaped groove 252 located on the base wall 251 corresponding to the magnetic gap 27 so as to provide an extra space 2521. There is no doubt that a depth of the magnetic gap 27 became longer along a direction of the vibration of coils.

While the present disclosure has been described with reference to the specific embodiments, the description of the invention is illustrative and is not to be construed as limiting the invention. Various of modifications to the present invention can be made to the exemplary embodiment by those skilled in the art without departing from the true spirit and scope of the invention as defined by the appended claims.

What is claimed is:

1. A micro-speaker, comprising:
a frame forming a hollow space;
a diaphragm attached to the frame;
a yoke received in the hollow space and attached to the frame;
a magnet received in the yoke, a pole plate attached on the magnet and forming a magnetic gap together with the yoke;
a voice coil activating the diaphragm;
a pair of conductive terminals attached to the housing; wherein
the voice coil includes one end connected directly or indirectly with the diaphragm, another end received in the magnetic gap, and a pair of leads extending from the other end of the voice coil for electrically connecting with the pair of conductive terminals;
the yoke defines a base wall provided with a groove corresponding to the magnetic gap for providing an extra space to the leads of the voice coil for avoiding bumping against the leads of the voice coil.

2. The micro-speaker as described in claim 1, wherein the base wall is configured to be rectangular shape, and the groove comprises a pair of grooves corresponding to the leads of the voice coil.

3. The micro-speaker as described in claim 2, wherein the yoke further defines a pair of longitudinal sidewalls extending upwardly and perpendicularly from the longitudinal outer periphery of the base wall for mounting the frame, the grooves located in the latitude periphery of the base wall.

4. The micro-speaker as described in claim 3, wherein each of the longitudinal sidewalls defines a main wall, a pair of auxiliary wall extending from two ends of the main wall, and a pair of inclining portions extending from the auxiliary wall.

5. The micro-speaker as described in claim 4, wherein the frame defines a positioning portion extending from inner sidewalls of the frame and received in the hollow space.

6. The micro-speaker as described in claim 5, wherein a nick is formed by the main wall and the auxiliary wall for engaging with the positioning portion.

7. The micro-speaker as described in claim 6, wherein the frame further includes a fence extending into the hollow space of the frame for embedding the pair of conductive terminals.

8. The micro-speaker as described in claim 7, wherein a width of the groove is greater than that of the thickness of the voice coil.

9. A micro-speaker, comprising:
a frame defining a chamber formed by a plurality of inner walls;
a yoke received in the chamber defining a base wall, a pair of sidewalls extending parallel to each other;
a magnet located on the yoke;
a magnetic gap formed between the magnet and the yoke;
a pair of conductive terminals assembled with the frame;
a voice coil partially received in the magnetic gap;
a diaphragm driven by the voice coil for producing sound waves; wherein
the voice coil includes a pair of leads extending from one end of the voice coil far away from the diaphragm for electrically connecting with the pair of conductive terminals;
the yoke defines a recess formed in the base wall and between the sidewalls for providing an extra space to the voice coil for avoiding bumping against the leads.

10. The micro-speaker as described in claim 9, wherein the voice coil is substantially configured to be rectangular shape, the leads are provided on the short side of the voice coil.

11. The micro-speaker as described in claim 10, wherein the leads is suspended above the recess.

12. The micro-speaker as described in claim 11, wherein the frame further includes a fence extending into hollow space of the frame for embedding the pair of conductive terminals.

13. The micro-speaker as described in claim 10, wherein the recess is substantially a closed-loop.

14. The micro-speaker as described in claim 13, wherein a width of the recess is greater than a thickness of the voice coil.

15. A micro-speaker, comprising:
a frame defining a chamber formed by a plurality of inner walls;
a yoke received in the chamber defining a base wall in shape of circle, a pair of sidewalls extending parallel to each other;
a magnet located on the yoke;
a magnetic gap formed between the magnet and the yoke;
a pair of conductive terminals assembled with the frame;
a voice coil partially received in the magnetic gap;
a diaphragm driven by the voice coil for producing sound waves; wherein
the voice coil includes a pair of leads extending from one end of the voice coil far away from the diaphragm for connecting with the pair of conductive terminals;
the yoke defines a groove formed in the base wall corresponding to the magnetic gap for providing an extra space to voice coil for avoiding bumping against the leads.

16. The micro-speaker as described in claim 15, wherein a width of the groove is greater than a thickness of the voice coil.

17. The micro-speaker as described in claim 16, wherein the frame further includes a fence extending from the inner sidewalls of the frame for embedding the pair of conductive terminals.
